(19) United States
(12) Patent Application Publication
(10) Pub. No.: US 2026/0349372 A1
(43) Pub. Date: Nov. 5, 2026

(54) TONER CARTRIDGE WITH TORQUE LIMITER

(71) Applicant: Hewlett-Packard Development Company, L.P., Spring, TX (US)

(72) Inventors: Jong In Kim, Seongnam-city, Gyeonggi-do (KR); Jinsam Park, Seongnam-city, Gyeonggi-do (KR); Dong Uk Kim, Seongnam-city, Gyeonggi-do (KR); Ki Hyun Yoo, Seongnam-city, Gyeonggi-do (KR)

(73) Assignee: Hewlett-Packard Development Company, L.P., Spring, TX (US)

(21) Appl. No.: 19/101,730

(22) PCT Filed: May 22, 2023
(86) PCT No.: PCT/US2023/023145

§ 371 Date: Feb. 6, 2025

(30) Foreign Application Priority Data
Sep. 8, 2022 (KR) 10-2022-0114519

(51) Int. Cl. G03G 15/08

(52) U.S. Cl. CPC G03G 15/0889; G03G 2215/085

(57) ABSTRACT

A toner cartridge includes a toner container having an opening at one end thereof and to rotate about a rotation axis to transfer a toner toward the opening; an outlet to discharge the toner supplied from the toner container to the outside; a stirrer coupled to the one end of the toner container and spaced apart from the outlet; and a torque limiter provided between the toner container and the stirrer to transmit a torque of less than a set value between the toner container and the stirrer.

### BACKGROUND

The image forming apparatus forms an image by forming an electrostatic latent image by scanning light onto a surface of a rotating photoreceptor using a light exposure device, forming a toner image by supplying a toner to the surface of the photoreceptor on which the electrostatic latent image is formed through a developing device, transferring the toner image to a print medium using a transfer device, and fixing the toner image to the print medium by pressing and heating the toner image transferred to the print medium using a fixing device.

The toner may be supplied to the developing device through a toner cartridge, and a rotary toner cartridge may be used as the toner cartridge.

### BRIEF DESCRIPTION OF THE DRAWINGS

Various examples will be described below by referring to the following figures.

FIG. 1 is a perspective view illustrating a toner cartridge assembly for supplying a toner to a developing device of an image forming apparatus, according to an example.

FIG. 2 is a perspective view of a toner cartridge, according to an example.

FIG. 3 is an exploded perspective view of the toner cartridge, according to an example.

FIG. 4 is a partial cross-sectional view of the toner cartridge, according to an example.

FIG. 5 is a partial perspective view illustrating a partial portion of a toner container of the toner cartridge, according to an example.

FIG. 6 is a perspective view illustrating a stirrer of the toner cartridge, according to an example.

FIG. 7 is a perspective view illustrating the toner cartridge in a state where the stirrer is coupled to the toner container, according to an example.

FIG. 8 is a cross-sectional view illustrating the toner cartridge in a state where the stirrer is coupled to the toner container, according to an example.

FIG. 9 is a cross-sectional view taken along line I-I of FIG. 8, according to an example.

FIG. 10 is a cross-sectional view illustrating the toner cartridge of FIG. 4 taken along line II-II, according to an example.

FIG. 11 is a partial perspective view illustrating a toner container of a toner cartridge, according to an example.

FIG. 12 is a perspective view illustrating a stirrer of the toner cartridge, according to an example.

FIG. 13 is a partial cross-sectional view illustrating a state in which the stirrer of FIG. 12 is coupled to the toner container of FIG. 11, according to an example.

FIG. 14 is a partial side view illustrating a toner cartridge in a state in which a stirrer is coupled to a toner container, according to an example.

FIG. 15 is a cross-sectional view taken along line III-III of FIG. 14, according to an example.

FIG. 16 is a partial cross-sectional view illustrating a toner cartridge in a state where a stirrer is coupled to a toner container, according to an example.

FIG. 17 is a cross-sectional view taken along line IV-IV of FIG. 16, according to an example.

### DETAILED DESCRIPTION

Various examples now will be described more fully hereinafter with reference to the accompanying drawings. The examples described below may be modified in various forms. To more clearly illustrate the features of the examples, a detailed description thereof will be omitted by those skilled in the art to which the present invention belongs.

It will be understood that when an element is referred to as being “coupled” or “connected” to another element, there may be other elements in the middle, although it may be directly coupled or connected to the other element. In addition, when a certain part is referred to as “including” a certain element, which is not intended to exclude other components unless specifically stated otherwise but may further comprise other components.

“Image forming apparatus” refers to a device that prints printing data generated by a terminal device like a computer onto a recording printing medium. An example of the image forming apparatus is a copier, a printer, a facsimile, or a multi-function printer (MFP) comprehensively implementing functions thereof into one device.

Examples described hereinafter are for easy understanding of the disclosure, and it should be understood that various changes can be made to the examples described herein and the disclosure can be embodied in different forms.

In addition, in the following description, detailed descriptions of well-known functions or configurations will be omitted since they would unnecessarily obscure the subject matters of the disclosure. In addition, it should be noted that the drawings as attached are just for easy understanding of the disclosure, and are not illustrated as really scaled, and dimensions of some elements may be exaggerated.

An electrophotographic image forming apparatus may include a main body forming an exterior, a paper feeding device, a light exposure device, a photoreceptor, a developing device, a transfer device, a fixing device, and a paper discharge device.

The disclosure relates to a developing device of an electrophotographic image forming apparatus. The electrophotographic image forming apparatus may include one developing device. The electrophotographic image forming apparatus which is to include one developing device may perform mono printing. The developing device may include a toner cartridge for supplying a toner.

As another example, the electrophotographic image forming apparatus may include a plurality of developing devices. The image forming apparatus which is to include a plurality of developing devices may perform mono printing and color printing.

The disclosure relates to a developing device of an electrophotographic image forming apparatus. For example, the disclosure relates to a toner cartridge for supplying a toner to the developing device.

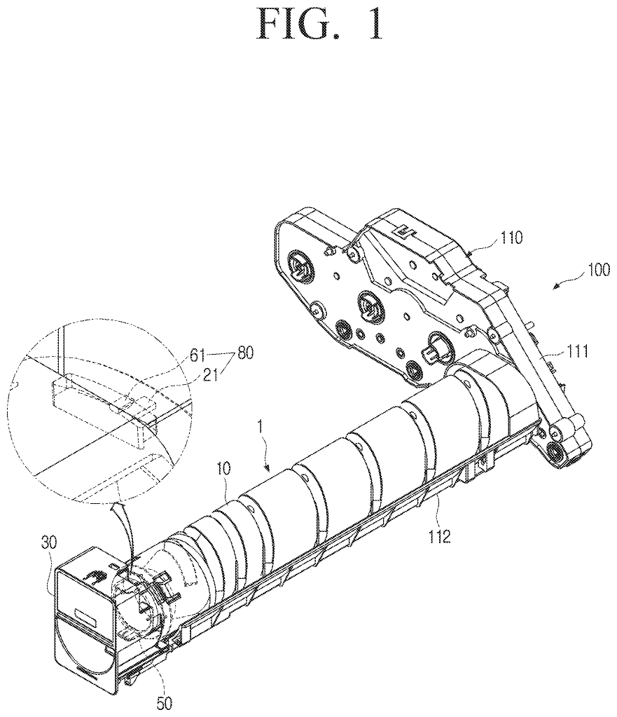

A toner cartridge assembly 100 includes a toner cartridge 1 according to an example of the disclosure and will be described with reference to FIG. 1.

FIG. 1 is a perspective view illustrating a toner cartridge assembly for supplying a toner to a developing device of an image forming apparatus according to an example of the disclosure. Referring to FIG. 1, the toner cartridge assembly 100 may include a driving device 110 and a toner cartridge 1. The driving device 110 may be formed to drive at least one toner cartridge. The driving device 110 illustrated in FIG. 1 is formed to drive four toner cartridges. For convenience of illustration, FIG. 1 illustrates a state in which one toner cartridge 1 is mounted in the driving device 110. The driving device 110 may include a motor, a power transmission device 111 for driving the four toner cartridges 1, and a cartridge receiving part 112 for receiving and supporting the toner cartridges 1

When the motor operates, the four toner cartridges 1 may be driven by the power transmission device 111. When the toner cartridge 1 is driven, the toner accommodated in the toner cartridges I may be supplied to a toner buffer. The toner buffer may be formed to receive a certain amount of toner and supply the received toner to the developing device.

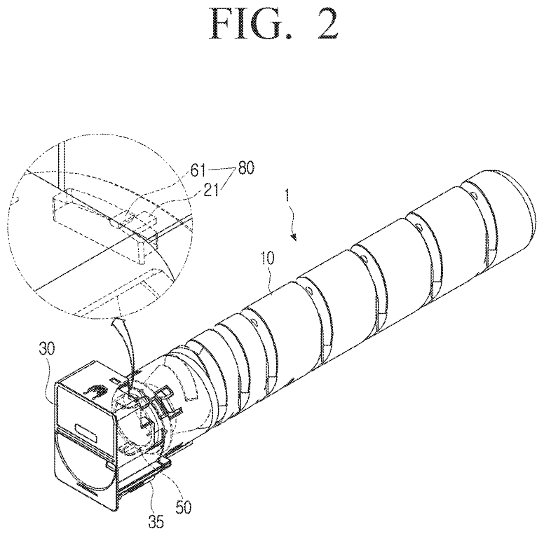

Hereinafter, the toner cartridge 1 according to an example of the disclosure will be described in detail with reference to FIGS. 2 to 10.

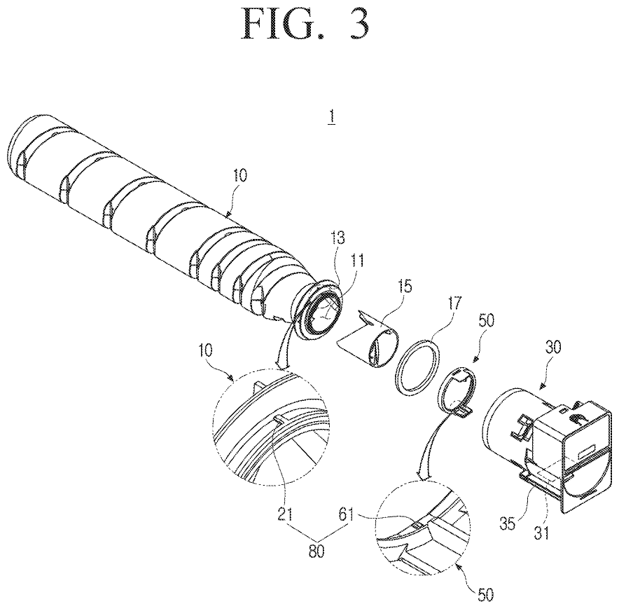

FIG. 2 is a perspective view of the toner cartridge according to an example of the disclosure. FIG. 3 is an exploded perspective view of the toner cartridge according to an example of the disclosure. Referring to FIGS. 2 and 3, the toner cartridge 1 may include a toner container 10, a holder 30, and a stirrer 50. The toner container 10 may contain a toner therein. An opening 11 may be provided at one end of the toner container 10. A spiral protrusion may be provided on an inner side surface of the toner container 10. Accordingly, when the toner container 10 is rotated about a rotation axis by the driving device 110, the toner may be transferred toward the opening 11 by the spiral protrusion.

The holder 30 may be coupled to one end of the toner container 10. The holder 30 is formed to rotatably support the toner container 10. The toner discharged from the opening 11 provided at one end of the toner container 10 may be supplied into the holder 30.

The holder 30 may include an outlet 31 formed to discharge the toner supplied from the toner container 10 to the outside of the holder 30. The outlet 31 may be provided in a lower surface of the bolder 30.

A shutter 35 may be provided in the outlet 31 to open or close the outlet 31. When the shutter 35 is opened, the toner in the holder 30 may be supplied to the outside, that is, to the toner buffer. When the shutter 35 is closed, the toner in the holder 30 may not be discharged to the outside.

The stirrer 50 coupled to one end of the toner container 10 may be provided inside the holder 30. The stirrer 50 may be coupled to one end of the toner container 10 in such a manner as to be positioned above the outlet 31. The stirrer 50 may be provided inside the holder 30 in such a manner as to be spaced apart from the outlet 31. The stirrer 50 may be rotated as the toner container 10 rotates.

A torque limiter 80 may be provided between the toner container 10 and the stirrer 50. The torque limiter 80 may include a locking protrusion 21 and an accommodation protrusion 61. The locking protrusion 21 may be formed on the toner container 10. The torque limiter 80 may be formed to transmit a torque of less than a set value between the toner container 10 and the stirrer 50.

For example, when the toner container 10 rotates, if a load applied to the stirrer 50 is less than the set value, the stirrer 50 to which the torque has been transmitted through the torque limiter 80 may be rotated by the toner container 10. Here, the load applied to the stirrer 50 may be a force applied to the stirrer 50 by the toner accommodated in the holder 30. If the toner becomes hardened or compacted, the load applied by the toner to the stirrer 50 may be large. If the toner is not hardened or compacted, the load applied by the toner to the stirrer 50 may be small.

The set value of the load applied by the toner to the stirrer 50 may be determined based on the type of toner. When the toner container 10 rotates, if a load applied to the stirrer 50 is more than or equal to the set value, the stirrer 50 may not be rotated by the toner container 10 because the torque limiter 80 transmits no torque. That is, the stirrer 50 may remain stationary regardless of whether or not the toner container 10 rotates

The toner container 10 may include an auxiliary transfer member 15 provided adjacent to the opening 11 in the toner container 10 and formed to rotate integrally with the toner container 10 such that the toner inside the toner container 10 is discharged through the opening 11.

The auxiliary transfer member 15 may be fixed inside the toner container 10 to rotate integrally with the toner container 10. The auxiliary transfer member 15 may be formed in a shape capable of discharging the toner inside the toner container 10 through the opening 11. The auxiliary transfer member 15 may be provided not to protrude from one end of the toner container 10.

The toner container 10 may include an annular plate 13 provided adjacent to one end of the toner container 10. The annular plate 13 may extend vertically in an annular shape from an outer circumferential surface of the toner container 10. A sealing member 17 may be fixed to the annular plate 13.

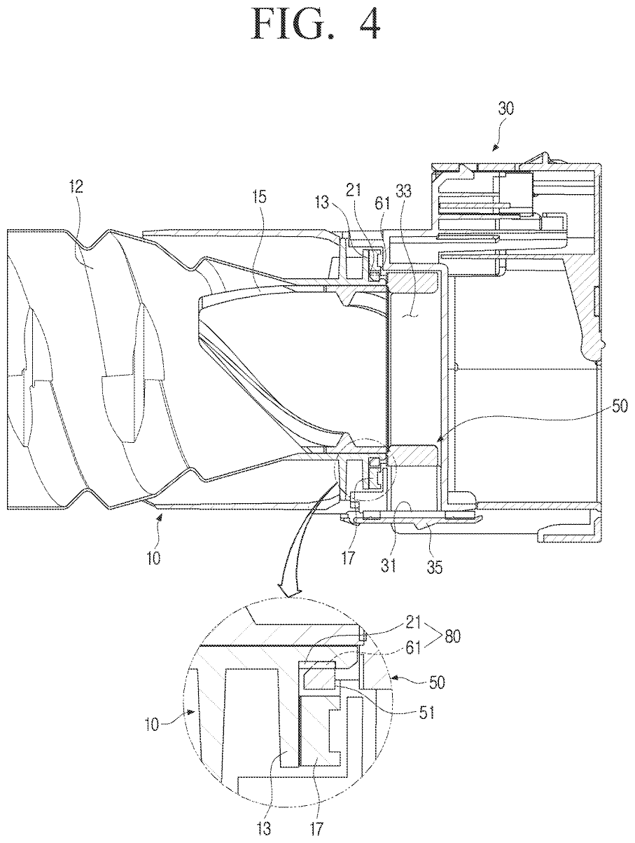

Hereinafter, a coupling structure between the toner container 10 and the holder 30 of the toner cartridge 1 will be described in detail with reference to FIGS. 4 to 10.

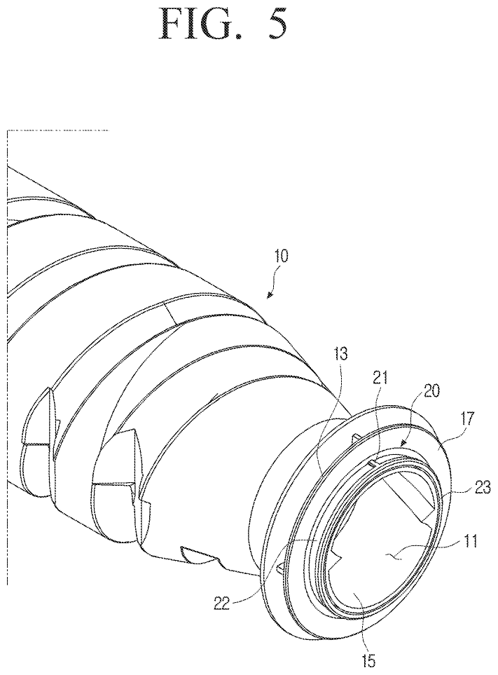

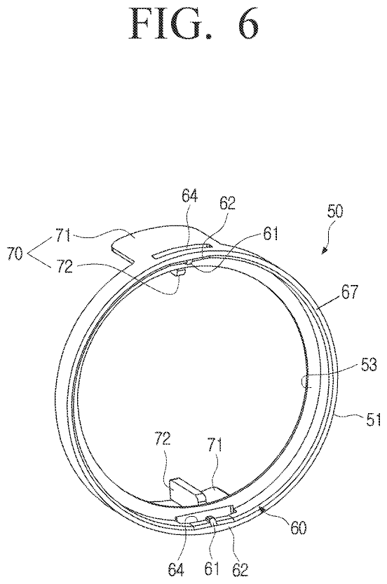

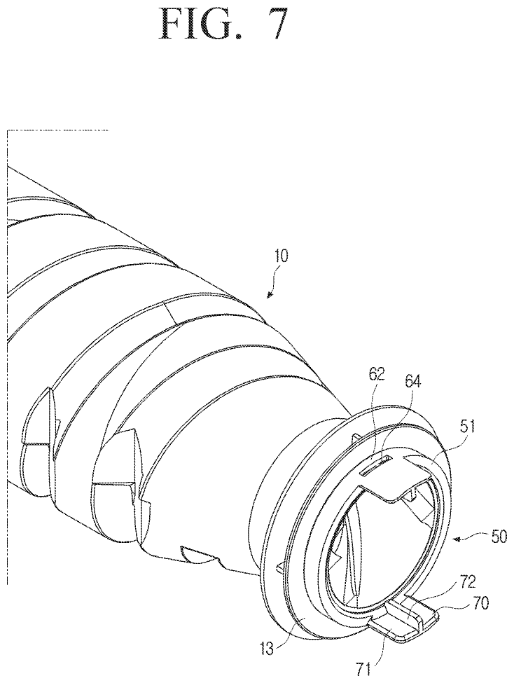

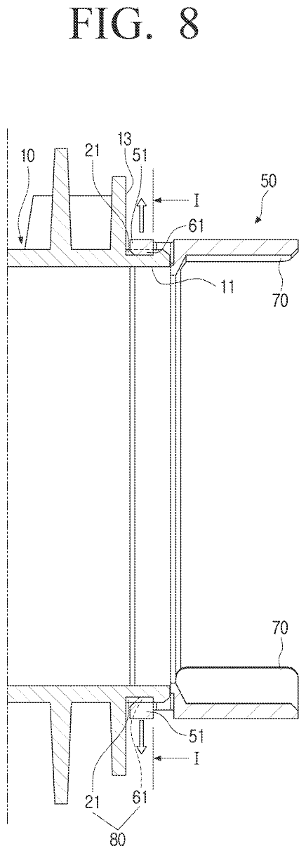

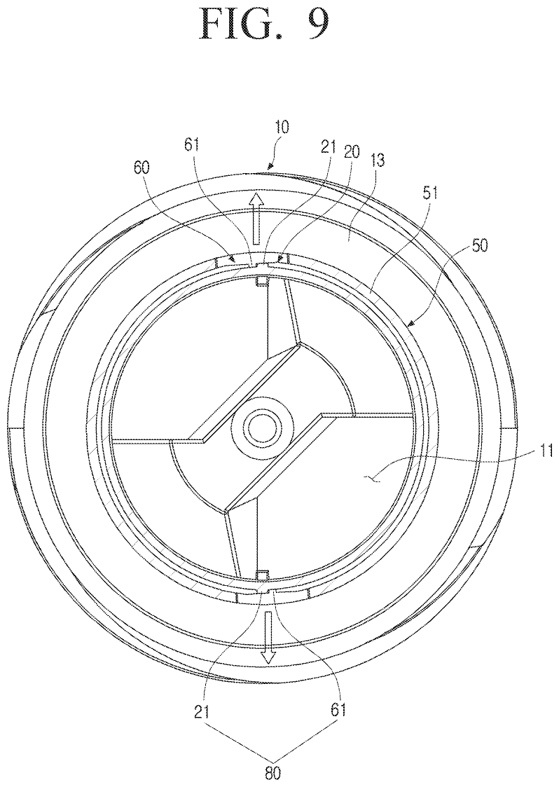

FIG. 4 is a partial cross-sectional view of the toner cartridge according to an example of the disclosure. FIG. 5 is a partial perspective view illustrating a partial portion of the toner container of the toner cartridge according to an example of the disclosure. FIG. 6 is a perspective view illustrating the stirrer of the toner cartridge according to an example of the disclosure. FIG. 7 is a perspective view illustrating the toner cartridge in a state where the stirrer is coupled to the toner container according to an example of the disclosure. FIG. 8 is a cross-sectional view illustrating the toner cartridge in a state where the stirrer is coupled to the toner container according to an example of the disclosure. FIG. 9 is a cross-sectional view taken along line I-I of FIG. 8.

Referring to FIG. 4, the toner cartridge 1 may include the toner container 10 and the holder 30. The holder 30 may be coupled to one end of the toner container 10. One end portion of the toner container 10 may be formed in a tapered shape or a funnel shape to be inserted into the holder 30.

One end of the toner container 10 may be rotatably supported by the holder 30. The other end of the toner container 10 may be connected to the driving device 110 (see FIG. 1). Accordingly, when the driving device 110 operates, the toner container 10 may rotate in a state where the holder 30 is fixed.

A spiral protrusion 12 may be provided on an inner side surface of the toner container 10, and an opening 11 may be provided at one end of the toner container 10. Accordingly, when the toner container 10 rotates, the toner accommodated in the toner container 10 may be discharged to the holder 30 through the opening 11.

A toner space 33 may be provided in the holder 30 to accommodate the toner discharged from the opening 11 of the toner container 10. An outlet 31 communicating with the toner space 33 may be provided in the lower surface of the holder 30. Accordingly, the toner discharged from the opening 11 of the toner container 10 may be discharged to the outlet 31 after passing through the toner space 33 of the holder 30.

A shutter 35 may be provided around the outlet 31 of the holder 30 to selectively open or close the outlet 31. When the toner cartridge 1 is not mounted on the image forming apparatus, the outlet 31 of the holder 30 is blocked by the shutter 35. When the toner cartridge 1 is mounted on the image forming apparatus, for example, when the toner cartridge 1 is mounted on the cartridge receiving part 112 (see FIG. 1) of the driving device 110 (see FIG. 1), the shutter 35 opens the outlet 31 of the holder 30. Accordingly, when the toner container 10 rotates, the toner in the toner container 10 may be discharged to the outside, for example, to the toner buffer, through the outlet 31 of the holder 30.

A stirrer 50 may be provided at one end of the toner container 10. The stirrer 50 may be coupled to one end of the toner container 10. The stirrer 50 provided at one end of the toner container 10 may be positioned above the outlet 31.

When a torque is transmitted to the stirrer 50 through the torque limiter 80, the stirrer 50 may be rotated by the toner container 10. The stirrer 50 provided at one end of the toner container 10 may be rotated in the toner space 33. When the stirrer 50 is rotated by the toner container 10, the toner in the toner space 33 may be smoothly discharged to the outlet 31.

However, when the toner in the toner space 33 is compacted and the toner density increases, the stirrer 50 may not rotate even though the toner container 10 rotates because no torque is transmitted to the stirrer 50 through the torque limiter 80. That is, only the toner container 10 may rotate in a state where the stirrer 50 remains fixed to the toner.

An auxiliary transfer member 15 may be provided at one end of the toner container 10 inside. The auxiliary transfer member 15 may be provided adjacent to the opening 11 in the toner container 10. One end of the auxiliary transfer member 15 may be flush with one end of the toner container 10. An outer diameter of the auxiliary transfer member 15 may be smaller than an inner diameter of the opening 11 of the toner container 10. Accordingly, the auxiliary transfer member 15 may be inserted into the opening 11 of the toner container 10 to be fixed inside the toner container 10.

The auxiliary transfer member 15 may rotate integrally with the toner container 10, so that the toner in the toner container 10 is discharged through the opening 11. That is, the toner moved toward the opening 11 by the spiral protrusion 12 inside the toner container 10 may be discharged to the outside of the toner container 10 by the auxiliary transfer member 15 provided in the opening 11.

Referring to FIG. 5, an opening 11 and the annular plate 13 may be provided at one end of the toner container 10. The opening 11 of the toner container 10 may be formed in a circular shape. The annular plate 13 may be provided to be spaced apart from one end of the toner container 10 by a predetermined distance toward the other end of the toner container 10. The annular plate 13 may be formed to extend vertically from an outer circumferential surface of the toner container 10. The annular plate 13 may be formed of an annular or donut-shaped plate.

A torque transmission portion 20 may be provided at one end of the toner container 10. The torque transmission portion 20 may be provided on the outer circumferential surface of the toner container 10 between one end of the toner container 10 and the annular plate 13. The torque transmission portion 20 may include the locking protrusion 21 protruding in a radial direction from the outer circumferential surface of the toner container 10.

The locking protrusion 21 may be formed in a rectangular parallelepiped shape with a width and a height being small and a length being large. The length of the locking protrusion 21 may correspond to a distance between one end of the toner container 10 and the annular plate 13.

The locking protrusion 21 may include at least one protrusion. The toner container 10 according to an example illustrated in FIGS. 4 and 5 includes two locking protrusions 21. The two locking protrusions 21 provided on the toner container 10 may be spaced apart from each other by 180 degrees. The number of locking protrusions 21 may be two, but any number of protrusions may be provided.

The torque transmission portion 20 may include a rib 23 provided at one end of the toner container 10. The rib 23 may be formed to prevent the stirrer 50 coupled to one end of the toner container 10 from escaping from the toner container 10 in an axial direction.

The rib 23 may be provided to protrude in the radial direction at one end of the toner container 10. The rib 23 may be formed along an entire circumference of the outer circumferential surface of one end of the toner container 10. For example, the rib 23 may be formed in an annular shape. The rib 23 may be formed at the same height as the locking protrusion 21.

When the rib 23 is formed at one end of the toner container 10, a guide groove 22 may be provided between the annular plate 13 and the rib 23. The guide groove 22 may be formed along the entire circumference of the outer circumferential surface of the toner container 10. The guide groove 22 may have a smaller diameter than the rib 23. Therefore, the guide groove 22 and the rib 23 may form a step.

At least one locking protrusion may be provided in the guide groove 22. The locking protrusion 21 may be formed to have a length corresponding to a gap between the annular plate 13 and the rib 23. The toner container 10 illustrated in FIG. 5 includes two locking protrusions 21 provided in the guide groove 22.

An outer end edge of the rib 23 may be chamfered. By chamfering the rib 23, the stirrer 50 may be easily coupled to the guide groove 22 of the toner container 10. A sealing member 17 may be provided on the annular plate 13 of the toner container 10 outward of the rib 23. The sealing member 17 may be formed in an annular shape. The sealing member 17 may be provided on the annular plate 13 to be spaced apart from the guide groove 22 of the toner container 10 by a predetermined distance.

Referring to FIG. 6, the stirrer 50 may include a connection portion 51, a torque receiving portion 60, and a stirring portion 70. The connection portion 51 may be formed in an annular shape. An inner diameter of the connection portion 51 may be larger than an outer diameter of one end of the toner container 10. The inner diameter of the connection portion 51 may be larger than an outer diameter of the rib 23 provided at one end of the toner container 10. Accordingly, the connection portion 51 may be fitted onto one end of the toner container 10.

The torque receiving portion 60 may be provided on an inner circumferential surface of the connection portion 51. The torque receiving portion 60 may be coupled to the torque transmission portion 20 provided in the toner container 10 to transmit a rotation of the toner container 10 to the stirrer 50. Accordingly, the torque transmission portion 20 of the toner container 10 and the torque receiving portion 60 of the stirrer 50 may form the torque limiter 80.

The torque receiving portion 60 may include an accommodation protrusion 61 protruding in the radial direction from the inner circumferential surface of the connection portion 51. The accommodation protrusion 61 may be formed in a shape corresponding to that of the locking protrusion 21 of the toner container 10.

The accommodation protrusion 61 may be formed in a rectangular parallelepiped shape with a width and a height being small and a length being large. The length of the accommodation protrusion 61 may correspond to the length of the locking protrusion 21. A side surface of the accommodation protrusion 61 may be formed to be in face-to-face contact with a side surface of the locking protrusion 21. For example, when the side surface of the locking protrusion 21 has a rectangular shape, the side surface of the accommodation protrusion 61 may also have a rectangular shape.

The accommodation protrusion 61 may include at least one protrusion. The number of accommodation protrusions 61 provided in the stirrer 50 may be the same as the number of locking protrusions 21 in the toner container 10. The stirrer 50 illustrated in FIGS. 4 and 6 includes two accommodation protrusions 61. The two accommodation protrusions 61 may be provided on the inner circumferential surface of the connection portion 51 to be spaced apart from each other by 180 degrees.

Although the torque receiving portion 60 is formed as an accommodation protrusion 61 in the above-described example, the disclosure is not limited thereto. As another example, the torque receiving portion 60 may be formed as an accommodation groove. In this case, the accommodation groove may be formed in a shape corresponding to that of the locking protrusion 21 of the torque transmission portion 20. For example, the accommodation groove may be formed in a shape to allow the locking protrusion 21 to be inserted therein to selectively transmit a torque.

The torque receiving portion 60 may include an elastic portion 62 supporting the accommodation protrusion 61. The elastic portion 62 supports the accommodation protrusion 61 such that the accommodation protrusion 61 may be displaced in the radial direction of the toner container 10. Accordingly, when a force is applied to the accommodation protrusion 61, the accommodation protrusion 61 may be moved in the radial direction of the toner container 10 by the elastic portion 62.

To this end, the stirrer 50 illustrated in FIG. 6 may include a slot 64 formed downward of the accommodation protrusion 61 in the connection portion 51. The slot 64 may be formed in a straight shape while penetrating through the connection portion 51. By forming the slot 64 in the connection portion 51, a partial portion of the connection portion 51 in which the accommodation protrusion 61 is provided becomes in the form of a beam of which both ends are supported, so that the accommodation protrusion 61 may be displaced in the radial direction. Therefore, the elastic portion 62 allowing the accommodation protrusion 61 to be displaced in the radial direction may be formed in a partial portion of the connection portion 51 upward of the slot 64.

An inner edge of one end of the connection portion 51 may be chamfered. By providing a chamfer on the connection portion 51, the stirrer 50 may be fitted onto the toner container 10. A stopper 53 may be provided at the other end of the connection portion 51. The stopper 53 may be formed to restrict the stirrer 50 from moving toward the annular plate 13 of the toner container 10.

The stopper 53 may be formed along the inner circumferential surface of the connection portion 51 at the other end of the connection portion 51. The stopper 53 may be formed in an annular shape. An inner diameter of the stopper 53 may be smaller than the inner diameter of the connection portion 51. The inner diameter of the stopper 53 may be equal to the inner diameter of the opening 11 of the toner container 10. When the auxiliary transfer member 15 is provided in the opening 11 of the toner container 10, the inner diameter of the stopper 53 may be equal to an inner diameter of the auxiliary transfer member 15.

The stirring portion 70 may be provided at one end of the connection portion 51. The stirring portion 70 may be formed to stir a toner accommodated in the toner space 33 of the holder 30. The stirrer 50 may include at least one stirring portion. The stirrer 50 illustrated in FIGS. 4 and 6 includes two stirring portions 70.

The stirring portion 70 may include an extension plate 71 extending from the connection portion 51 and a stirring pin 72 protruding from the extension plate toward the center of the connection portion 51.

The extension plate 71 may be formed in a substantially rectangular plate shape. The extension plate 71 may be formed of a curved plate having a curvature corresponding to that of the connection portion 51.

The stirring pin 72 may be formed perpendicular to the extension plate 71 on an inner surface of the extension plate 71. The stirring pin 72 may be formed in an approximately rectangular shape. The stirring pin 72 may be formed to stir a toner in the toner space 33 provided in the holder 30. If the stirring pin 72 has a large area, the stirring pin 72 may stir the toner easily. However, when the toner in the toner space 33 is compacted and its density increases, a toner load applied to the stirrer 50 may increase. The stopper 53 may be provided between the connection portion 51 and the stirring portion 70.

Referring to FIGS. 7 to 9, the stirrer 50 may be coupled to one end of the toner container 10. When the stirrer 50 is coupled to one end of the toner container 10, by pushing the stirrer 50 in the axial direction in a state where one end of the connection portion 51 of the stirrer 50 is in contact with the rib 23 of the toner container 10, the accommodation protrusion 61 of the stirrer 50 may be accommodated in the guide groove 22 of the toner container 10 after riding on and going over the rib 23 of the toner container 10. At this time, since the rib 23 of the toner container 10 and the connection portion 51 of the stirrer 50 are chamfered, the stirrer 50 may be easily coupled to one end of the toner container 10

Once the accommodation protrusion 61 of the stirrer 50 is accommodated in the guide groove 22 of the toner container 10, the stirrer 50 does not escape from the toner container 10. The stirrer 50 may have a clearance in the axial direction of the toner container 10 to correspond to a difference between the width of the guide groove 22 of the toner container 10 and the length of the accommodation protrusion 61.

When the accommodation protrusion 61 of the stirrer 50 comes into contact with the locking protrusion 21 of the toner container 10, the stirrer 50 may be rotated by the toner container 10. For example, when the toner container 10 rotates in a state where the side surface of the locking protrusion 21 of the toner container 10 and the side surface of the accommodation protrusion 61 of the stirrer 50 are in contact with each other, the stirrer 50 may be rotated integrally with the toner container 10 by the locking protrusion 21 and the accommodation protrusion 61.

When the stirrer 50 rotates, the toner accommodated in the toner space 33 of the holder 30 may be stirred and discharged through the outlet 31. However, when the toner accommodated in the toner space 33 of the holder 30 is in a certain state, even though the toner container 10 rotates, the stirrer 50 may not rotate. That is, the rotation of the toner container 10 may or may not be transmitted to the toner cartridge 1 through the torque limiter 80, that is, the torque transmission portion 20 and the torque receiving portion 60. For example, the rotation of the toner container 10 may or may not be transmitted to the stirrer 50 depending on the density of the toner in the toner space 33 of the holder 30.

When the toner in the toner space 33 of the holder 30 is compacted and the toner has a high density, a load applied by the toner to the stirrer 50 may be large. When the toner in the toner space 33 is not in a compacted state, the toner has a low density. In this case, a load applied by the toner to the stirrer 50 may be small.

In the disclosure, the stirrer 50 may be rotated by the toner container 10 when the load applied by the toner to the stirrer 50 is less than the set value, and the stirrer 50 may not be rotated by the toner container 10 when the load applied by the toner to the stirrer 50 is more than or equal to the set value.

The set value may be appropriately determined according to the properties of the toner, the capacity of the motor of the driving device 110, and the like.

The rotation of the toner container 10 may or may not be transmitted to the stirrer 50 through the torque transmission portion 20 of the toner container 10 and the torque receiving portion 60 of the stirrer 50. That is, the torque transmission portion 20 and the torque receiving portion 60 may form the torque limiter 80.

When the load applied to the stirrer 50 is less than the set value, the rotation of the toner container 10 may be transmitted to the stirrer 50 through the torque transmission portion 20 and the torque receiving portion 60. Then, the stirrer 50 may rotate to stir the toner in the toner space 33.

When the load applied to the stirrer 50 is more than or equal to the set value, the rotation of the toner container 10 may not be transmitted to the stirrer 50 through the torque transmission portion 20 and the torque receiving portion 60. Then, the stirrer 50 does not rotate, and thus, the toner in the toner space 33 is not stirred.

In addition, since the toner container 10 spins with no traction with respect to the stirrer 50, the motor of the driving device 110 rotating the toner container 10 may not be overloaded. Accordingly, the motor may be prevented from being out of step or the driving device 110 may be prevent from being damaged.

FIGS. 8 and 9 illustrate a case in which the stirrer 50 is not overloaded, that is, a load more than or equal to the set value is not applied to the stirrer 50. In this case, the locking protrusion 21 of the toner container 10 is coupled to the accommodation protrusion 61 of the stirrer 50. That is, when the side surface of the locking protrusion 21 of the toner container 10 and the side surface of the accommodation protrusion 61 of the stirrer 50 come into contact with each other and the toner container 10 rotates, the accommodation protrusion 61 is rotated by the locking protrusion 21 that rotates integrally with the toner container 10. When the accommodation protrusion 61 rotates, the stirrer 50 on which the accommodation protrusion 61 is provided rotates integrally with the accommodation protrusion 61 to stir a toner accommodated in the toner space 33.

When the stirrer 50 is overloaded, that is, when a load of more than or equal to the set value is applied to the stirring portion 70 of the stirrer 50, the stirrer 50 may not be rotated by the toner container 10. That is, the accommodation protrusion 61 of the stirrer 50 may be displaced in the radial direction of the stirrer 50 to decouple the locking protrusion 21 and the accommodation protrusion 61 from each other, so that the rotation of the toner container 10 is not transmitted to the stirrer 50.

At this time, since the stirrer 50 remains fixed by the toner, the toner container 10 may rotate relative to the stirrer 50. That is, only the toner container 10 may rotate in a state where the stirrer 50 is fixed.

When the stirrer 50 is fixed, the locking protrusion 21 provided in the toner container 10 rides on the accommodation protrusion 61. That is, the locking protrusion 21 of the toner container 10 applies a force to the accommodation protrusion 61. When the force is applied to the accommodation protrusion 61, the accommodation protrusion 61 is deformed in the radial direction (an arrow direction in FIGS. 8 and 9) because the accommodation protrusion 61 is supported by the elastic portion 62. Then, the locking protrusion 21 of the toner container 10 may go over the accommodation protrusion 61 of the stirrer 50.

After the locking protrusion 21 of the toner container 10 goes over the accommodation protrusion 61 of the stirrer 50, the accommodation protrusion 61 returns to its original state by the elastic portion 62. That is, the accommodation protrusion 61 of the stirrer 50 may be restored in the radial direction toward the center of the stirrer 50 by the elastic portion 62. Accordingly, the accommodation protrusion 61 of the stirrer 50 may be vibrated by the locking protrusion 21 of the toner container 10. In other words, vibration may be generated in the stirrer 50 by the locking protrusion 21 of the toner container 10 in a rotating state and the accommodation protrusion 61 of the stirrer 50.

The vibration generated by the locking protrusion 21 of the toner container 10 and the accommodation protrusion 61 of the stirrer 50 may be repeatedly generated due to the rotation of the toner container 10. A vibration generation cycle may be determined depending on the number of locking protrusions 21 provided in the toner container 10 and the number of accommodation protrusions 61 provided in the stirrer 50.

When the stirrer 50 repeatedly vibrates due to the rotation of the toner container 10, the toner accommodated in the toner space 33 of the holder 30 may fall to the outlet 31 by the vibration. When an amount of the toner in the toner space 33 decreases, the load applied by the toner to the stirrer 50 may decrease. When the load to the stirrer 50 decreases to less than the set value, the stirrer 50 may be rotated integrally with the toner container 10 by the locking protrusion 21 and the accommodation protrusion 61, which is the torque limiter 80.

To allow the stirrer 50 to rotate integrally with the toner container 10 or prevent the stirrer 50 from being rotated by the toner container 10 based on the set value for the toner load, a set value for a torque allowed to be transmitted by the torque limiter 80 may be adjusted. For example, the setting value for the torque may be adjusted by adjusting an amount of interference, that is, a contact area, between the locking protrusion 21 and the accommodation protrusion 61 of the torque limiter 80. In an example, the setting value for the torque may be adjusted using the shapes and materials of the locking protrusion 21 and the accommodation protrusion 61. In an example, the setting value for the torque may be adjusted using the elasticity, shape, and the like of the elastic portion 62 supporting the accommodation protrusion 61.

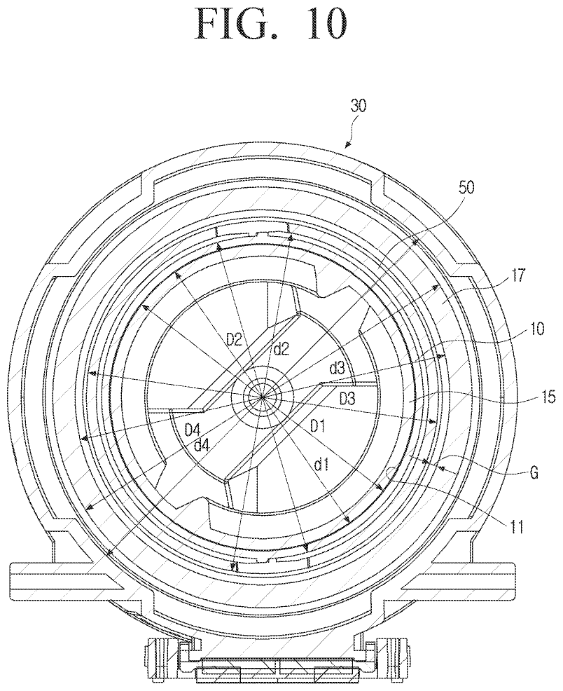

Relationships between inner diameters and outer diameters of the components constituting the toner cartridge 1 for minimizing a change in torque during the rotation of the toner container 10 will be described with reference to FIG. 10.

FIG. 10 is a cross-sectional view illustrating the toner cartridge of FIG. 4 taken along line II-II. Referring to FIG. 10, the inner diameters and the outer diameters of the components constituting the toner cartridge 1 may satisfy the following condition.

The outer diameter (D1) of auxiliary transfer member 15<inner diameter (d1) of opening 11 of toner container 10<outer diameter (D2) of opening 11 of toner container 10<inner diameter (d2) of stirrer 50<outer diameter (D3) of stirrer 50<inner diameter (d3) of sealing member 17<outer diameter (D4) of sealing member 17<smallest inner diameter (d4) of holder 30.

That is, if the inner diameters and the outer diameters of the components constituting the toner cartridge 1 satisfy the above-described relationships, a change in torque during the rotation of the toner container 10 may be minimized.

Meanwhile, since the sealing member 17 is fixed to the annular plate 13 of the toner container 10 and rotates integrally with the toner container 10, in order for the stirrer 50 to be displaced in the radial direction, a sufficient gap G may exist between the inner diameter of the sealing member 17 and the outer diameter of the stirrer 50. That is, a space for the accommodation protrusion 61 to be displaced in the radial direction may be provided outward of the stirrer 50 on which the accommodation protrusion 61 is provided.

As a result, when the accommodation protrusion 61 of the stirrer 50 is displaced in a radially protruding direction by the locking protrusion 21 of the toner container 10, an outer circumferential surface of the stirrer 50 may not contact an inner circumferential surface of the sealing member 17.

In addition, when the stirrer 50 rotates integrally with the toner container 10 by coupling the locking protrusion 21 and the accommodation protrusion 61 to each other, the stirrer 50 may not interfere with the sealing member 17. Accordingly, the stirrer 50 may rotate integrally with the toner container 10 in a smooth way.

According to the disclosure having the above-described structure, when the toner is compacted and a load of more than or equal to the set value is applied to the stirrer 50, the stirrer 50 may not be rotated by the toner container 10 even though the toner container 10 rotates.

In this case, since vibration is generated in the stirrer 50 by the rotation of the toner container 10, the toner in the toner space 33 of the holder 30, in which the stirrer 50 is accommodated, may be discharged. When the toner in the toner space 33 is reduced, the load applied by the toner to the stirrer 50 may decrease and become less than the set value.

When a load of less than the set value is applied to the stirrer 50, the locking protrusion 21 of the toner container 10 may be coupled to the accommodation protrusion 61 of the stirrer 50. Then, the coupling of the locking protrusion 21 and the accommodation protrusion 61 to each other makes it possible to rotate the stirrer 50 integrally with the toner container 10.

That is, in the toner cartridge 1 according to the disclosure, the torque transmission portion 20 provided at one end of the toner container 10 and the torque receiving portion 60 provided in the stirrer 50 may function as the torque limiter 80 to allow the stirrer 50 to be rotated or not to be rotated in a selective manner depending on a torque applied to the stirrer 50.

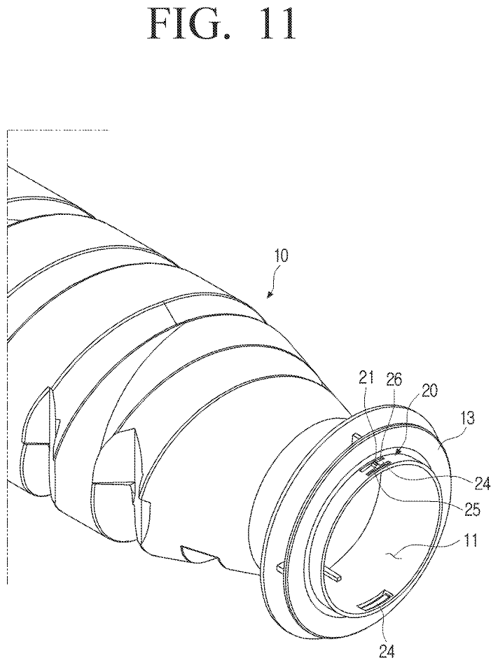

Although it has been described above that the rib 23 for preventing the stirrer 50 from escaping from the toner container 10 is provided at one end of the toner container 10, and the elastic portion 62 is provided in the stirrer 50, but the disclosure is not limited thereto. Hereinafter, another example of the disclosure will be described with reference to FIGS. 11 to 13.

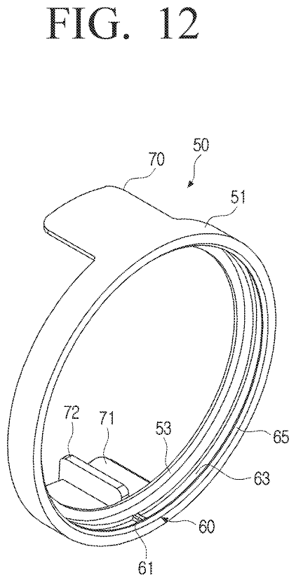

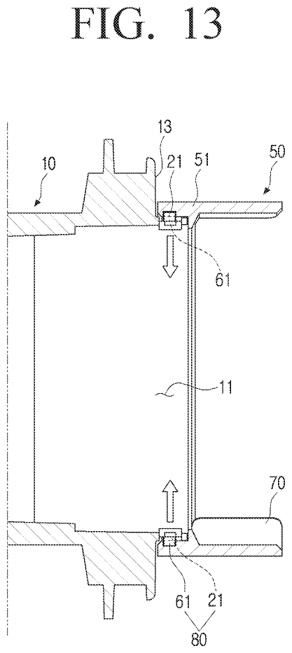

FIG. 11 is a partial perspective view illustrating a toner container of a toner cartridge according to an example of the disclosure. FIG. 12 is a perspective view illustrating a stirrer of the toner cartridge according to an example of the disclosure. FIG. 13 is a partial cross-sectional view illustrating a state in which the stirrer of FIG. 12 is coupled to the toner container of FIG. 11.

Referring to FIG. 11, an opening 11 and the annular plate 13 may be provided at one end of the toner container 10. The opening 11 of the toner container 10 may be formed in a circular shape. The annular plate 13 may be provided to be spaced apart from one end of the toner container 10 by a predetermined distance toward the other end of the toner container 10. The annular plate 13 may be formed to extend vertically from an outer circumferential surface of the toner container 10. The annular plate 13 may be formed of an annular or donut-shaped plate.

A torque transmission portion 20 may be provided at one end of the toner container 10. The torque transmission portion 20 may be provided on the outer circumferential surface of the toner container 10 between one end of the toner container 10 and the annular plate 13. The torque transmission portion 20 may include a locking protrusion 21 protruding in a radial direction from the outer circumferential surface of the toner container 10.

The locking protrusion 21 may include at least one protrusion. As an example, the toner container 10 illustrated in FIGS. 11 and 13 includes two locking protrusions 21. The two locking protrusions 21 may be spaced apart from each other by 180 degrees.

The torque transmission portion 20 may include an elastic portion 24 supporting the locking protrusion 21. The elastic portion 24 supports the locking protrusion 21 such that the locking protrusion 21 may be displaced in the radial direction of the toner container 10. Accordingly, when a force is applied to the locking protrusion 21, the locking protrusion 21 may be moved in the radial direction of the toner container 10 by the elastic portion 24.

To this end, the toner container 10 illustrated in FIG. 11 may include an upper slot 25 and a lower slot 26 formed upward and downward the locking protrusion 21, respectively, at one end thereof. The upper slot 25 and the lower slot 26 may be formed in a straight shape while penetrating through one end of the toner container 10. The upper slot 25 and the lower slot 26 may be formed symmetrically with respect to the locking protrusion 21. The upper slot 25 and the lower slot 26 may be formed in the same shape.

By forming the upper slot 25 and the lower slot 26 at one end of the toner container 10, a partial portion of the toner container 10 in which the locking protrusion 21 is provided becomes in the form of a beam of which both ends are supported, so that the locking protrusion 21 may be displaced in the radial direction. Therefore, the elastic portion 42 allowing the locking protrusion 21 to be displaced in the radial direction may be formed in a partial portion of the toner container 10 between the upper slot 25 and the lower slot 26.

Referring to FIG. 12, the stirrer 50 may include the connection portion 51, the torque receiving portion 60, and the stirring portion 70. The connection portion 51 may be formed in an annular shape. An inner diameter of the connection portion 51 may be larger than an outer diameter of one end of the toner container 10.

The torque receiving portion 60 may be provided on an inner circumferential surface of the connection portion 51. The torque receiving portion 60 may be coupled to the torque transmission portion 20 provided in the toner container 10 to transmit a rotation of the toner container 10 to the stirrer 50.

The torque receiving portion 60 may include an accommodation protrusion 61 protruding in the radial direction from the inner circumferential surface of the connection portion 51. The accommodation protrusion 61 may be formed in a shape corresponding to that of the locking protrusion 21 of the toner container 10. A length of the accommodation protrusion 61 may correspond to a length of the locking protrusion 21. A side surface of the accommodation protrusion 61 may be formed to be in face-to-face contact with a side surface of the locking protrusion 21. For example, when the side surface of the locking protrusion 21 has a rectangular shape, the side surface of the accommodation protrusion 61 may also have a rectangular shape.

The accommodation protrusion 61 may include at least one protrusion. The number of accommodation protrusions 61 provided in the stirrer 50 may be the same as the number of locking protrusions 21 in the toner container 10. The stirrer 50 illustrated in FIGS. 12 and 13 includes two accommodation protrusions 61. The two accommodation protrusions 61 may be provided on the inner circumferential surface of the connection portion 51 to be spaced apart from each other by 180 degrees.

The accommodation protrusion 61 may be formed in a guide groove 63 provided in the inner circumferential surface of the connection portion 51. The accommodation protrusion 61 may have a length corresponding to a width of the guide groove 63.

The guide groove 63 may be formed along an entire circumference of the connection portion 51. A depth of the guide groove 63 may be the same as a height of the accommodation protrusion 61. A diameter of the guide groove 63 may be larger than the inner diameter of the connection portion 51.

A side wall 65 of the guide groove 63 adjacent to one end of the stirrer 50, that is, one end of the connection portion 51, may prevent the stirrer 50 coupled to one end of the toner container 10 from escaping from of the toner container 10 in an axial direction. The side wall 65 of the guide groove 63 may be formed in an annular shape. Therefore, the side wall 65 of the guide groove 63 in the stirrer 50 may perform the same function as the rib 23 provided in the toner container 10 in the above-described example.

One end of the toner container 10 may be coupled to the connection portion 51 of the stirrer 50. The inner diameter of the connection portion 51 may be larger than the outer diameter of one end of the toner container 10. Accordingly, the connection portion 51 may be fitted onto one end of the toner container 10.

An inner edge of one end of the connection portion 51 may be chamfered. By providing a chamfer on the inner side of one end of the connection portion 51, the stirrer 50 may be easily coupled to one end of the toner container 10.

The stopper 53 may be provided at the other end of the connection portion 51. The stopper 53 may be formed to restrict the stirrer 50 from moving toward the annular plate 13 of the toner container 10.

The stopper 53 may be formed along the inner circumferential surface of the connection portion 51 at the other end of the connection portion 51. The stopper 53 may be formed in an annular shape. An inner diameter of the stopper 53 may be smaller than the inner diameter of the connection portion 51.

The stirring portion 70 may be provided at one end of the connection portion 51. The stirring portion 70 may be formed to stir a toner accommodated in the toner space 33 of the holder 30. Since the stirring portion 70 is the same as that of the stirrer 50 of the toner cartridge 1 in the above-described example, the detailed description thereof will be omitted.

Referring to FIG. 13, the stirrer 50 may be coupled to one end of the toner container 10. When the stirrer 50 is coupled to one end of the toner container 10, by pushing the stirrer 50 in the axial direction in a state where one end of the connection portion 51 of the stirrer 50 is in contact with one end of the toner container 10, the locking protrusion 21 of the toner container 10 may be accommodated in the guide groove 63 (see FIG. 12) of the stirrer 50 after riding on and going over the side wall 65 (see FIG. 12) of the guide groove 63 (see FIG. 12) of the stirrer 50

When the locking protrusion 21 of the toner container 10 is accommodated in the guide groove 63 (see FIG. 12) of the stirrer 50, the stirrer 50 does not escape from the toner container 10. A clearance may exist in the axial direction of the toner container 10 between the stirrer 50 and one end of the toner container 10 to correspond to a difference between the width of the guide groove 63 (see FIG. 12) of the stirrer 50 and the length of the locking protrusion 21 of the toner container 10.

When the accommodation protrusion 61 of the stirrer 50 comes into contact with the locking protrusion 21 of the toner container 10, the stirrer 50 may be rotated by the toner container 10. For example, when the toner container 10 rotates in a state where the side surface of the locking protrusion 21 of the toner container 10 and the side surface of the accommodation protrusion 61 of the stirrer 50 are in contact with each other, the stirrer 50 may be rotated integrally with the toner container 10 by the locking protrusion 21 and the accommodation protrusion 61.

When the stirrer 50 rotates, the toner accommodated in the toner space 33 of the holder 30 may be stirred and discharged through the outlet 31. However, when the stirrer 50 is overloaded, the stirrer 50 may not rotate integrally with the toner container 10 even though the toner container 10 rotates.

When the stirrer 50 is overloaded and the stirrer 50 is fixed, the locking protrusion 21 provided in the toner container 10 rides on the accommodation protrusion 61. That is, the locking protrusion 21 of the toner container 10 applies a force to the accommodation protrusion 61. At this time, since the locking protrusion 21 is supported by the elastic portion 24, the locking protrusion 21 is deformed in the radial direction (an arrow direction in FIG. 13). Then, the locking protrusion 21 of the toner container 10 may ride on and go over the accommodation protrusion 61 of the stirrer 50.

After the locking protrusion 21 of the toner container 10 goes over the accommodation protrusion 61 of the stirrer 50, the locking protrusion 21 returns to its original state by the elastic portion 24. That is, the locking protrusion 21 of the toner container 10 may return to its original position in the radial direction toward the center of the toner container 10 by the elastic portion 24. Accordingly, when the toner container 10 rotates, the locking protrusion 21 of the toner container 10 may vibrate by the accommodation protrusion 61 of the stirrer 50. When the locking protrusion 21 of the toner container 10 vibrates, this vibration may be transmitted to the stirrer 50. When the stirrer 50 vibrates, the toner accommodated in the toner space 33 of the holder 30 may be discharged to the outside through the outlet 31.

When an amount of the toner in the toner space 33 decreases, the load applied by the toner to the stirrer 50 may decrease. When the load to the stirrer 50 decreases to less than the set value, the stirrer 50 may be rotated integrally with the toner container 10 by the locking protrusion 21 and the accommodation protrusion 61 coupled to each other.

In other words, the torque transmission portion 20 of the toner container 10 and the torque receiving portion 60 of the stirrer 50 may form the torque limiter 80. Accordingly, the rotation of the toner container 10 may or may not be transmitted to the stirrer 50 depending on a load applied by the toner to the stirrer 50.

Although it has been described above that the elastic portion 24 or 62 is provided in one of the toner container 10 and the stirrer 50, the disclosure is not limited thereto. The elastic portions 24 and 62 may be provided in both the toner container 10 and the stirrer 50. For example, a first elastic portion 24 supporting the locking protrusion 21 may be provided in the toner container 10, and a second elastic portion 62 supporting the accommodation protrusion 61 may be provided in the stirrer 50.

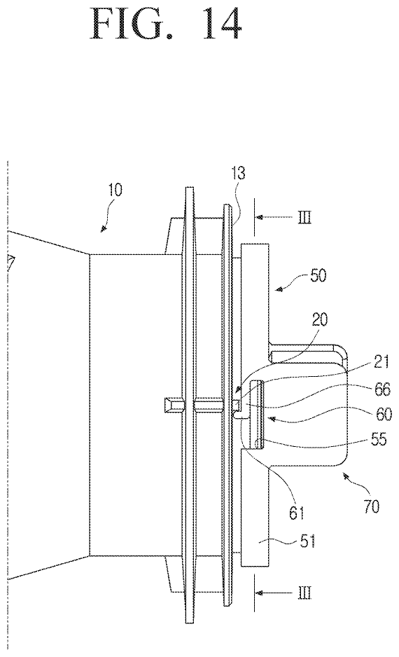

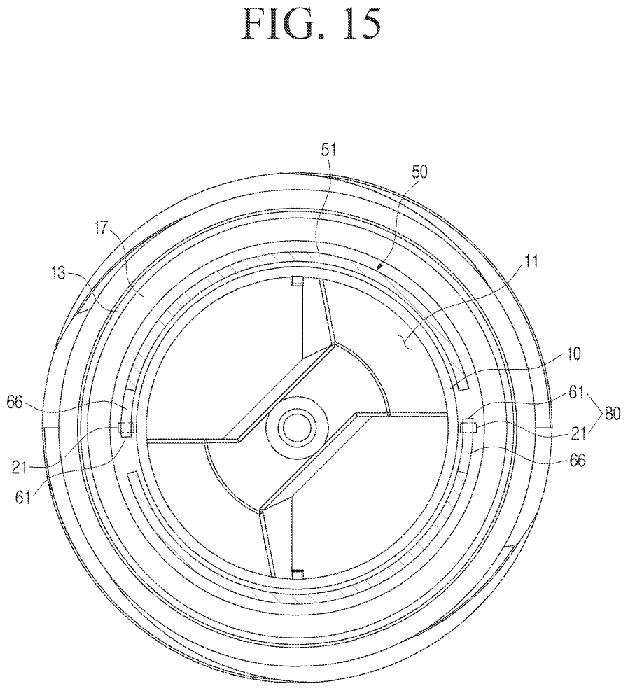

Although it has been described above that the locking protrusion 21 is formed on the outer circumferential surface of the toner container 10, the disclosure is not limited thereto. Hereinafter, a toner cartridge I according to an example of the disclosure will be described with reference to FIGS. 14 and 15.

FIG. 14 is a partial side view illustrating a toner cartridge in a state where a stirrer is coupled to a toner container according to an example of the disclosure. FIG. 15 is a cross-sectional view taken along line II-III of FIG. 14.

Referring to FIGS. 14 and 15, the opening 11 and the annular plate 13 may be provided at one end of the toner container 10. The opening 11 of the toner container 10 may be formed in a circular shape. The annular plate 13 may be provided to be spaced apart from one end of the toner container 10 by a predetermined distance toward the other end of the toner container 10. The annular plate 13 may be formed to extend vertically from an outer circumferential surface of the toner container 10. The annular plate 13 may be formed of an annular or donut-shaped plate.

A torque transmission portion 20 may be provided at one end of the toner container 10. The torque transmission portion 20 may be provided on the annular plate 13. The torque transmission portion 20 may be provided between the outer circumferential surface of one end of the toner container 10 and the sealing member 17 provided on the annular plate 13. The torque transmission portion 20 may be provided on one surface of the annular plate 13 on which the sealing member 17 is provided.

The torque transmission portion 20 may include a locking protrusion 21 protruding from the annular plate 13 toward one end of the toner container 10. The locking protrusion 21 may be formed in a rectangular parallelepiped shape with a width and a height being small and a length being large. The length of the locking protrusion 21 may correspond to a distance between the outer circumferential surface of one end of the toner container 10 and the sealing member 17 provided on the annular plate 13. For example, the locking protrusion 21 may be formed to have a length smaller than the distance between the outer circumferential surface of one end of the toner container 10 and the sealing member 17.

The locking protrusion 21 may include at least one protrusion. As an example, the toner container 10 illustrated in FIGS. 14 and 15 includes two locking protrusions 21. The two locking protrusions 21 provided on the annular plate 13 may be spaced apart from each other by 180 degrees.

The stirrer 50 may include the connection portion 51, the torque receiving portion 60, and the stirring portion 70. The connection portion 51 may be formed in an annular shape. An inner diameter of the connection portion 51 may be larger than an outer diameter of one end of the toner container 10.

The torque receiving portion 60 may be provided at one end of the stirrer 50, that is, at one end of the connection portion 51. For example, the torque receiving portion 60 may be provided at one end of the connection portion 51 facing the annular plate 13 of the toner container 10.

The torque receiving portion 60 of the stirrer 50 may be formed to be coupled to the torque transmission portion 20 of the toner container 10. The torque receiving portion 60 may be coupled to the torque transmission portion 20 provided in the toner container 10 to transmit a rotation of the toner container 10 to the stirrer 50.

The torque receiving portion 60 may be formed as an accommodation protrusion 61 protruding in an axial direction from one end of the stirrer 50 facing the annular plate 13, and contacting and coupled to the locking protrusion 21 of the torque transmission portion 20.

For example, the torque receiving portion 60 may include an extension portion 66 formed in a circumferential direction at one end of the connection portion 51 facing the annular plate 13, and an accommodation protrusion 61 protruding from the front end of the extension portion 66 toward the annular plate 13.

The extension portion 66 may support the accommodation protrusion 61 such that the accommodation protrusion 61 may be displaced in the axial direction. That is, the extension portion 66 may perform the same function as the elastic portion of the toner cartridge 1 according to the above-described example. The extension portion 66 may be provided in a groove 55 having a rectangular shape and formed at one end of the connection portion 51. That is, the extension portion 66 may be formed to protrude from one side wall toward the other side wall of the groove 55. The extension portion 66 may be formed to be shorter than a length of the groove 55. The extension portion 66 may be formed in a cantilever shape. Accordingly, the accommodation protrusion 61 provided at the front end of the extension portion 66 may be displaced in the axial direction of the stirrer 50.

The accommodation protrusion 61 may be provided at the front end of the extension portion 66. The accommodation protrusion 61 may be formed in a shape corresponding to that of the locking protrusion 21 of the toner container 10. A length of the accommodation protrusion 61 may correspond to a length of the locking protrusion 21. A side surface of the accommodation protrusion 61 may be formed to be in face-to-face contact with a side surface of the locking protrusion 21. For example, when the side surface of the locking protrusion 21 has a rectangular shape, the side surface of the accommodation protrusion 61 may also have a rectangular shape.

The accommodation protrusion 61 may include at least one protrusion. The number of accommodation protrusions 61 provided in the stirrer 50 may be the same as the number of locking protrusions 21 in the toner container 10. The stirrer 50 illustrated in FIG. 15 includes two extension portions 66 and two accommodation protrusions 61. The two accommodation protrusions 61 may be provided at one end of the connection portion 51 to be spaced apart from each other by 180 degrees.

An inner diameter of the connection portion 51 may be larger than an outer diameter of one end of the toner container 10. Accordingly, the connection portion 51 may be fitted onto one end of the toner container 10. An inner edge of one end of the connection portion 51 may be chamfered. By providing a chamfer on the inner side of one end of the connection portion 51, the stirrer 50 may be easily coupled to one end of the toner container 10.

The stirring portion 70 may be provided at the other end of the connection portion 51. The stirring portion 70 may be formed to stir a toner accommodated in the toner space 33 of the holder 30. Since the stirring portion 70 is the same as that of the stirrer 50 of the toner cartridge 1 in the above-described example, the detailed description thereof will be omitted.

The torque transmission portion 20 of the toner container 10 and the torque receiving portion 60 of the stirrer 50 may form the torque limiter 80. Accordingly, the rotation of the toner container 10 may or may not be transmitted to the stirrer 50 depending on a load applied by the toner to the stirrer 50.

When the load applied to the stirrer 50 is less than the set value, the locking protrusion 21 of the toner container 10 may be coupled to the accommodation protrusion 61 of the stirrer 50, so that the stirrer 50 rotates integrally with the toner container 10.

When the load applied to the stirrer 50 is more than or equal to the set value, the rotation of the toner container 10 is not transmitted to the stirrer 50. Accordingly, even though the toner container 10 rotates, the stirrer 50 does not rotate. For example, when the stirrer 50 is overloaded, the accommodation protrusion 61 of the stirrer 50 is displaced in the axial direction of the stirrer 50 by the locking protrusion 21 of the toner container 10, and the locking protrusion 21 and the accommodation protrusion 61 are decoupled from each other. Accordingly, the rotation of the toner container 10 is not transmitted to the stirrer 50.

Specifically, the rotation of the toner container 10 causes the locking protrusion 21 to apply a force to the accommodation protrusion 61 of the stirrer 50. At this time, since the stirrer 50 is overloaded, the accommodation protrusion 61 does not rotate together with the locking protrusion 21, and the extension portion 66 is displaced toward the bottom of the groove 55. Then, the locking protrusion 21 of the toner container 10 goes over the accommodation protrusion 61 of the stirrer 50. When the locking protrusion 21 passes the accommodation protrusion 61, the accommodation protrusion 61 returns to its original state by the extension portion 66. Then, the stirrer 50 vibrates.

Since this vibration is repeatedly generated due to the rotation of the toner container 10, the toner accommodated in the toner space 33 of the holder 30 may be discharged to the outside through the outlet 31.

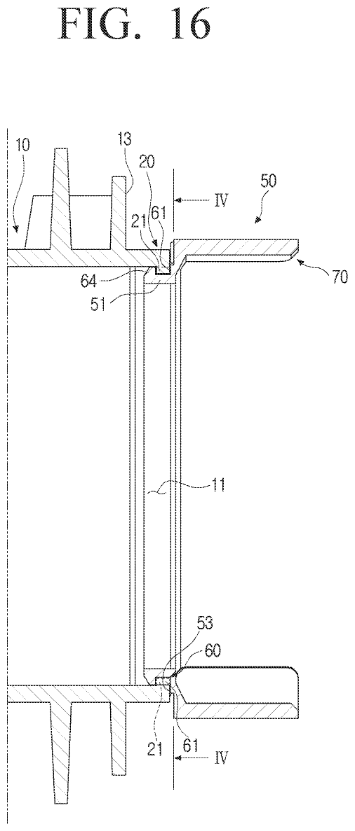

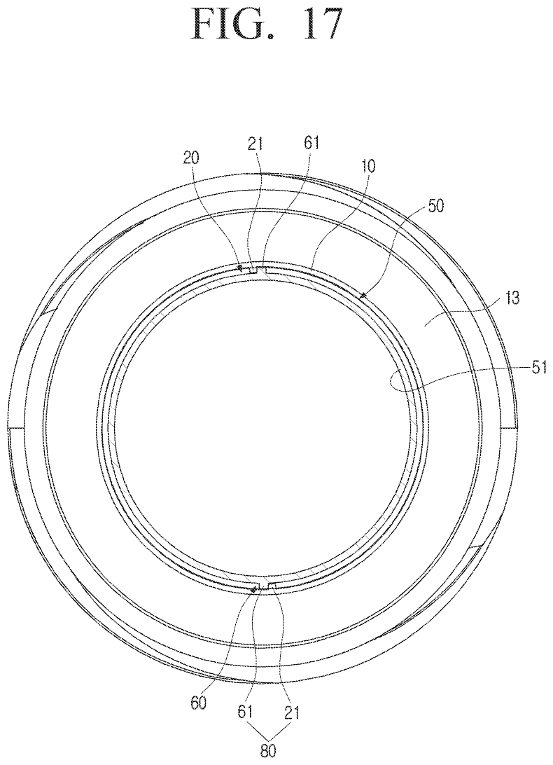

Although it has been described above that the locking protrusion 21 is formed on an outer side of one end of the toner container 10, the disclosure is not limited thereto. As an example, the locking protrusion 21 may be formed on an inner circumferential surface of one end of the toner container 10. Hereinafter, the case in which the locking protrusion 21 is formed on the inner circumferential surface of one end of the toner container 10 will be described with reference to FIGS. 16 and 17.

FIG. 16 is a partial cross-sectional view illustrating a toner cartridge in a state where a stirrer is coupled to a toner container according to an example of the disclosure. FIG. 17 is a cross-sectional view taken along line IV-IV of FIG. 16.

Referring to FIGS. 16 and 17, the opening 11 and the annular plate 13 may be provided at one end of the toner container 10. The opening 11 of the toner container 10 may be formed in a circular shape. The annular plate 13 may be provided to be spaced apart from one end of the toner container 10 by a predetermined distance toward the other end of the toner container 10. The annular plate 13 may be formed to extend vertically from an outer circumferential surface of the toner container 10.

A torque transmission portion 20 may be provided at one end of the toner container 10. The torque transmission portion 20 may be provided on an inner circumferential surface of one end of the toner container 10. The torque transmission portion 20 may include a locking protrusion 21 protruding in a radial direction from the inner circumferential surface of the toner container 10.

For example, the locking protrusion 21 may be formed in a rectangular parallelepiped shape with a width and a height being small and a length being large. The locking protrusion 21 may include at least one locking protrusion. As an example, the toner container 10 illustrated in FIGS. 16 and 17 includes two locking protrusions 21. The two locking protrusions 21 provided on the inner circumferential surface of the toner container 10 may be spaced apart from each other by 180 degrees.

The stirrer 50 may be formed to be inserted into one end of the toner container 10. The stirrer 50 may include the connection portion 51, the torque receiving portion 60, and the stirring portion 70.

The connection portion 51 may be formed in an annular shape. An outer diameter of the connection portion 51 may be larger than an inner diameter of the opening 11 at one end of the toner container 10. Accordingly, the connection portion 51 may be inserted into one end of the toner container 10.

The torque receiving portion 60 may be provided on an outer circumferential surface of the connection portion 51. The torque receiving portion 60 may be coupled to the torque transmission portion 20 provided in the toner container 10 to transmit a rotation of the toner container 10 to the stirrer 50.

The torque receiving portion 60 may include an accommodation protrusion 61 protruding in the radial direction from the outer circumferential surface of the connection portion 51. The accommodation protrusion 61 may be formed in a shape corresponding to that of the locking protrusion 21 of the toner container 10.

The accommodation protrusion 61 may be formed in a rectangular parallelepiped shape with a width and a height being small and a length being large. The length of the accommodation protrusion 61 may correspond to the length of the locking protrusion 21. A side surface of the accommodation protrusion 61 may be formed to be in face-to-face contact with a side surface of the locking protrusion 21. For example, when the side surface of the locking protrusion 21 has a rectangular shape, the side surface of the accommodation protrusion 61 may also have a rectangular shape.

The accommodation protrusion 61 may include at least one protrusion. The number of accommodation protrusions 61 provided in the stirrer 50 may be the same as the number of locking protrusions 21 in the toner container 10. The stirrer 50 illustrated in FIGS. 16 and 17 includes two accommodation protrusions 61. The two accommodation protrusions 61 may be provided on the outer circumferential surface of the connection portion 51 to be spaced apart from each other by 180 degrees.

The torque receiving portion 60 may include an elastic portion supporting the accommodation protrusion 61. The elastic portion supports the accommodation protrusion 61 such that the accommodation protrusion 61 may be displaced in the radial direction of the toner container 10. Accordingly, when a force is applied to the accommodation protrusion 61, the accommodation protrusion 61 may be moved in the radial direction of the toner container 10 by the elastic portion.

The torque receiving portion 60 may include a rib 67 provided at one end of the connection portion 51 of the stirrer 50. The rib 67 may be formed to prevent the stirrer 50 coupled to one end of the toner container 10 from escaping from the toner container 10 in an axial direction.

The rib 67 may be formed along an entire circumference of the outer circumferential surface of one end of the connection portion 51. For example, the rib 67 may be formed in an annular shape. The rib 67 may be formed at the same height as the accommodation protrusion 61.

The stopper 53 may be provided at the other end of the connection portion 51. The stopper 53 may be formed to restrict the stirrer 50 from moving toward the annular plate 13 of the toner container 10.

The stopper 53 may be formed along the outer circumferential surface of the connection portion 51 at the other end of the connection portion 51. The stopper 53 may be formed in an annular shape. An outer diameter of the stopper 53 may be larger than the outer diameter of the connection portion 51. The outer diameter of the stopper 53 may be equal to or larger than the outer diameter of the opening 11 of the toner container 10.

The stirring portion 70 may be provided at the other end of the connection portion 51, that is, the stopper 53. Since the stirring portion 70 is the same as that of the stirrer 50 of the toner cartridge 1 in the above-described example, the detailed description thereof will be omitted.

The torque transmission portion 20 of the toner container 10 and the torque receiving portion 60 of the stirrer 50 may form the torque limiter 80. Accordingly, the rotation of the toner container 10 may or may not be transmitted to the stirrer 50 depending on a load applied by the toner to the stirrer 50.

When the load applied to the stirrer 50 is less than the set value, the locking protrusion 21 of the toner container 10 may be coupled to the accommodation protrusion 61 of the stirrer 50, so that the stirrer 50 rotates integrally with the toner container 10.

When the load applied to the stirrer 50 is more than or equal to the set value, the rotation of the toner container 10 is not transmitted to the stirrer 50. Accordingly, even though the toner container 10 rotates, the stirrer 50 does not rotate. For example, when the stirrer 50 is overloaded, the accommodation protrusion 61 of the stirrer 50 is displaced in the axial direction of the stirrer 50 by the locking protrusion 21 of the toner container 10, and the locking protrusion 21 and the accommodation protrusion 61 are decoupled from each other. Accordingly, the rotation of the toner container 10 is not transmitted to the stirrer 50.

Specifically, the rotation of the toner container 10 causes the locking protrusion 21 to apply a force to the accommodation protrusion 61 of the stirrer 50. At this time, since the stirrer 50 is overloaded, the accommodation protrusion 61 does not rotate together with the locking protrusion 21, but is radially displaced toward the central axis of the toner container 10. Then, the locking protrusion 21 of the toner container 10 goes over the accommodation protrusion 61 of the stirrer 50. When the locking protrusion 21 passes the accommodation protrusion 61, the accommodation protrusion 61 returns to its original state by the elastic portion. Then, the stirrer 50 vibrates.

Since this vibration is repeatedly generated due to the rotation of the toner container 10, the toner accommodated in the toner space 33 of the holder 30 may be discharged to the outside through the outlet 31.

Although it has been described above that the locking protrusion 21 is formed on the toner container 10 and the accommodation protrusion 61 is formed on the stirrer 50, the disclosure is not limited thereto. As another example, a locking protrusion may be formed on the stirrer, and an accommodation protrusion may be formed on the toner container.

In a case where the toner cartridge 1 is distributed in a state where the holder 30 is positioned downward, a toner accommodated in the holder 30 may be compacted and a large load may be applied to the stirrer 50. In this case, in the toner cartridge 1 according to the disclosure, when a large load of more than or equal to the set value is applied to the stirrer 50, only the toner container 10 can rotate in a state where the stirrer 50 is fixed, thereby preventing the motor of the driving device 110 from being out of step or preventing the driving device 110 from being damaged.

In addition, in the toner cartridge 1 according to the disclosure, when the stirrer 50 does not rotate because of a compacted toner, the stirrer vibrates repeatedly according to the rotation of the toner container 10, making it possible to discharge the toner in the holder 30 to the outside. Then, the load applied to the stirrer 50 decreases, and as a result, the stirrer 50 can rotate integrally with the toner container 10.

In addition, in the toner cartridge 1 according to the disclosure, the stirrer 50 rotates or does not rotate depending on a density of a toner accommodated in the holder 30. Therefore, it is possible to form the stirring portion 70 of the stirrer 50 to have a large cross-sectional area. By forming the stirring portion 70 to have a large cross-sectional area, stirring performance can be increased, resulting in an improvement in toner discharge reliability of the toner cartridge 1.

In addition, the toner cartridge 1 according to the disclosure can be used even if a specific operation is not performed on the toner cartridge 1 or a prohibited operation is performed on the toner cartridge 1 before a user installs the toner cartridge 1 in an image forming apparatus. Accordingly, it is possible to improve user convenience with respect to the toner cartridge 1.

In addition, the toner cartridge 1 according to the disclosure can be distributed in a mounted state inside an image forming apparatus. Therefore, it is possible to reduce a packaging volume of the image forming apparatus as compared to that in a case where the toner cartridge 1 is separately packaged outside the image forming apparatus. Accordingly, it is possible to reduce a cost for transporting the image forming apparatus.

The disclosure has been described above with reference to the various examples. However, it is to be understood by those of ordinary skill in the art that various modifications may be made in form and detail without departing from the scope of the disclosure as defined by the appended claims and their equivalents.

1. A toner cartridge comprising:
a toner container having an opening at one end thereof and to rotate about a rotation axis to transfer a toner toward the opening;
an outlet to discharge the toner supplied from the toner container to the outside;
a stirrer coupled to the one end of the toner container and spaced apart from the outlet; and
a torque limiter provided between the toner container and the stirrer to transmit a torque of less than a set value between the toner container and the stirrer.

2. The toner cartridge as claimed in claim 1, wherein the torque limiter includes:
a first protrusion located on the toner container or the stirrer; and
a groove or a second protrusion located on the stirrer or the toner container to face the first protrusion.

3. The toner cartridge as claimed in claim 2, wherein the first protrusion protrudes in a radial direction from an outer circumferential surface of the one end of the toner container, and
the second protrusion protrudes in the radial direction from an inner circumferential surface of one end portion of the stirrer which is inserted into the one end of the toner container to contact the first protrusion.

4. The toner cartridge as claimed in claim 3, wherein when a load applied to the stirrer is less than the set value, the first protrusion of the toner container and the second protrusion of the stirrer are coupled to each other to transmit a rotation of the toner container to the stirrer, and
when the load applied to the stirrer is more than or equal to the set value, at least one of the first protrusion of the toner container and the second protrusion of the stirrer is displaced in the radial direction of the stirrer, and the first protrusion and the second protrusion are decoupled from each other, not to transmit the rotation of the toner container to the stirrer.

5. The toner cartridge as claimed in claim 4, wherein a space to displace the second protrusion in the radial direction is provided outward of the stirrer on which the second protrusion is provided.

6. The toner cartridge as claimed in claim 2, wherein the first protrusion protrudes in a radial direction from an inner circumferential surface of the one end of the toner container, and
the second protrusion protrudes in the radial direction from an outer circumferential surface of one end portion of the stirrer which is inserted into the one end of the toner container to contact the first protrusion.

7. The toner cartridge as claimed in claim 2, wherein the toner container includes a first elastic portion supporting the first protrusion to displace the first protrusion in a radial direction of the toner container.

8. The toner cartridge as claimed in claim 2, wherein the stirrer includes a second elastic portion supporting the second protrusion to displace the second protrusion in a radial direction of the stirrer.

9. The toner cartridge as claimed in claim 1, wherein at least one of the toner container and the stirrer includes a rib to prevent the stirrer from escaping from the toner container in an axial direction.

10. The toner cartridge as claimed in claim 2, wherein the toner container includes an annular plate extending vertically from an outer circumferential surface of the toner container, while being adjacent to the one end of the toner container,
the first protrusion protrudes from the annular plate toward the one end of the toner container, and
the second protrusion protrudes in an axial direction from one end of the stirrer facing the annular plate, and contacts the first protrusion to be coupled to the first protrusion.

11. The toner cartridge as claimed in claim 10, wherein when a load applied to the stirrer is more than or equal to the set value, the second protrusion of the stirrer is displaced in the axial direction of the stirrer by the first protrusion of the toner container, and the first protrusion and the second protrusion are decoupled from each other, not to transmit a rotation of the toner container to the stirrer.

12. The toner cartridge as claimed in claim 1, further comprising:
a holder coupled to the one end of the toner container to rotatably support the toner container; and
a sealing member provided between the toner container and the holder,
wherein the sealing member is provided on the toner container to surround the stirrer.

13. The toner cartridge as claimed in claim 1, further comprising an auxiliary transport member provided adjacent to the opening in the toner container to rotate integrally with the toner container and discharge the toner inside the toner container through the opening.

14. A toner cartridge comprising:
a toner container having an opening at one end thereof and to rotate about a rotation axis to transfer a toner toward the opening;
a stirrer coupled to the one end of the toner container to be positioned above an outlet;
a first protrusion protruding in a radial direction from an outer circumferential surface of the one end of the toner container; and
a second protrusion protruding in the radial direction from an inner circumferential surface of one end portion of the stirrer into which the one end of the toner container is inserted to contact the first protrusion.

15. An image forming apparatus comprising a toner cartridge,
wherein the toner cartridge includes:
a toner container having an opening at one end thereof and to rotate about a rotation axis to transfer a toner toward the opening;
an outlet to discharge the toner supplied from the toner container to the outside;
a stirrer coupled to the one end of the toner container and spaced apart from the outlet; and
a torque limiter provided between the toner container and the stirrer to transmit a torque of less than a set value between the toner container and the stirrer.
